(19) United States
(12) Patent Application Publication
(10) Pub. No.: US 2014/0289205 A1
(43) Pub. Date: Sep. 25, 2014

(54) DATA TRANSFER APPARATUS, SYSTEM, AND METHOD

(71) Applicant: Fujitsu Limited, Kawasaki-shi (JP)

(72) Inventor: Soichi Shigeta, Yokohama (JP)

(73) Assignee: FUJITSU LIMITED, Kawasaki-shi (JP)

(21) Appl. No.: 14/193,588

(22) Filed: Feb. 28, 2014

(30) Foreign Application Priority Data
Mar. 25, 2013 (JP) 2013-062383

(51) Int. Cl. G06F 17/30

(52) U.S. Cl. CPC G06F 17/3007
USPC 707/660

(57) ABSTRACT

An apparatus includes a memory, and a processor coupled to the memory. The processor is configured to determine a transfer purpose of data to be transferred from a first storage device to a second storage device via a network, and select transfer target data from data in the first storage device based on the determined transfer purpose of the data.

### CROSS-REFERENCE TO RELATED APPLICATION

This application is based upon and claims the benefit of priority of the prior Japanese Patent Application No. 2013-062383, filed on Mar. 25, 2013, the entire contents of which are incorporated herein by reference.

### FIELD

The embodiments discussed herein are related to an apparatus, system, and method regarding data transfer.

### BACKGROUND

A technology of remotely mirroring data among a plurality data centers is known. In the remote mirroring, data is mirrored to a data center with an extra capacity among the data centers as candidates for data transfer destinations.

A purpose for mirroring is to backup for disaster recovery (DR). Another purpose of mirroring is to prepare for virtual machine (hereinafter VM) migration. For the preparation purpose for VM migration, in preparation for VM migration for wide area load distribution, virtual disks of virtual machines in one data center are mirrored to another data center.

Examples of related art include those disclosed in Japanese Laid-open Patent Publication Nos. 2005-149285 and 2012-164185.

### SUMMARY

According to an aspect of the invention, an apparatus includes a memory, and a processor coupled to the memory. The processor is configured to determine a transfer purpose of data to be transferred from a first storage device to a second storage device via a network, and select transfer target data from data in the first storage device based on the determined transfer purpose of the data.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 depicts a data transfer system according to an embodiment;

FIG. 2 depicts an example of a band use status in the data transfer system according to the embodiment;

FIG. 3 depicts an entire structure of the data transfer system according to the embodiment;

FIG. 4 depicts an example of a VM information table;

FIG. 5 depicts an example of a disk information table;

FIG. 6 depicts an example of a status information table;

FIG. 7 depicts an example of a band information table;

FIG. 8 depicts an example of a site information table;

FIG. 9 depicts a functional structure of a storage control device according to an embodiment;

FIG. 10 depicts an example of a status information table;

FIG. 11 depicts an example of a status information table;

FIG. 12 depicts an example of a status information table;

FIG. 13 depicts an example of a status information table;

FIG. 14 depicts an example of a status information table;

FIG. 15 is a flowchart of a transfer purpose determining process according to an embodiment;

FIG. 16 is a flowchart of a transfer target data selecting process according to an embodiment;

FIG. 17 is a flowchart of a transfer target data selecting process in units of blocks according to an embodiment; and

FIG. 18 depicts a hardware structure of a storage control device according to an embodiment.

### DESCRIPTION OF EMBODIMENTS

Mirroring for a backup purpose for disaster recovery DR or the like and mirroring for a preparation purpose for VM migration are both performed via a network which couples data centers together. Therefore, if the data transfer amount by mirroring increases, a shortage of network bands may occur. The shortage of network bands affects all mirroring processes during execution whatever the purpose of mirroring is, and disadvantageously prolongs the time to complete mirroring.

Thus, it is desired to suppress a shortage of network bands.

Embodiments are described below with reference to the attached drawings. In the specification and drawings, components with substantially the same functional structure are provided with the same reference character and are not redundantly described.

Description of the Entire System

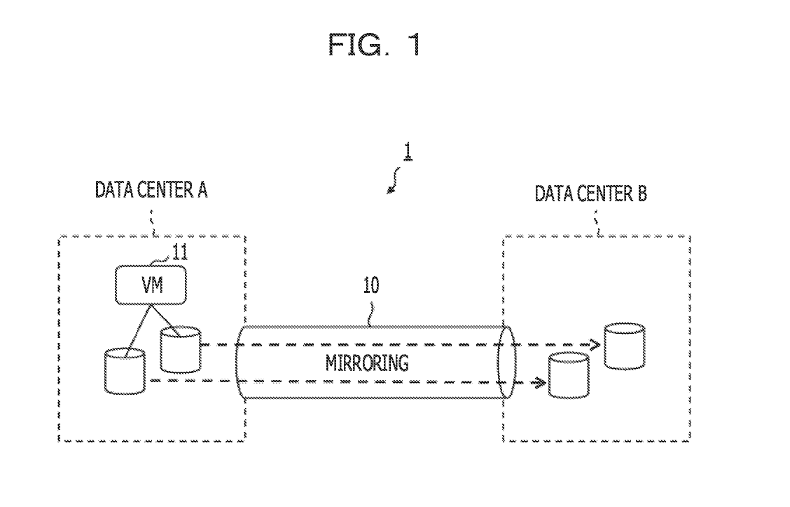

First, an embodiment of a data transfer system is described with reference to FIGS. 1, 2 and 3. FIGS. 1 to 3 are diagrams for describing the embodiment of the data transfer system.

A data transfer system 1 according to the present embodiment is embodied on a cloud computing system structure for providing resources such as a server, a storage, an OS, and middleware as services via a network. In the data transfer system 1 according to the present embodiment, a data center on a service provider side provides resources such as a server, a storage, an OS, and middleware prepared in advance in the data center to client apparatus on a user side as desired. However, the data transfer system 1 according to the present embodiment is not restricted to be embodied on a cloud computing system structure. The data transfer system 1 according to the present embodiment may have any system structure as long as the system includes two storage devices coupled to each other via a network and data is transferred from one of these two storage devices to the other storage device. In the following, storage devices in data centers are taken as an example for description.

Mirroring Among Storage Devices Via a Network

Mirroring (data transfer) according to the data transfer system 1 according to an embodiment is described with reference to FIG. 1. In the data transfer system 1 according to the present embodiment, a data center A and a data center B are coupled together via a wide area network (WAN) 10. The WAN 10 is an example of a network for coupling storage devices together, and the network is not restricted thereto. The network may be a dedicated line such as a local area network (LAN) or may be the Internet or the like.

Data in virtual disks generated by virtualization at the data center A is used by virtual machines (VMs) 11. In mirroring in the present embodiment, the data in the virtual disks are transferred by using a band of the WAN 10. In FIG. 1, the data in virtual disks at the data center A is transferred to the data center B by using a band of the WAN 10. As such, mirroring in the present embodiment is suitable for remote mirroring of a type of writing exactly the same data in a plurality of data centers.

Examples of purposes for mirroring include a backup purpose for disaster recovery DR and a preparation purpose for VM migration.

Mirroring for a backup purpose for disaster recovery DR is performed by assuming the case, for example, in which, when the data center A becomes not available due to an earthquake disaster or the like, data backed up in the data center B is used to recover the service of data center A.

Mirroring for the preparation purpose for VM migration is described below. With expansion of use of data centers, for example, several hundreds to several thousands of VMs 11 may have to be managed. On the other hand, resources such as server apparatuses and storage devices in one data center have a physical limit. For this reason, with an increase in the number of VMs 11 to be managed, there is a possibility that requests for using services from a user side may not be able to be fulfilled in one data center. To address this, a system is desired in which a plurality of data centers are brought in conjunction with each other and, even if a shortage of physical resources occurs at one data center, a physical resource at another data center is used, thereby addressing requests for using services. Thus, the VMs 11 are migrated from one data center where a shortage of resources occurs to another data center with extra resource supply capability to widely distribute the process loads on the VMs 11, thereby addressing expansion of demands for using services. For this reason, in mirroring for a preparation purpose for VM migration, aside from mirroring for disaster recovery DR, in preparation for migration of VMs 11 for wide area load distribution, the virtual disks of the VMs 11 in one data center are copied in advance to another data center.

In mirroring for a preparation purpose for VM migration, since a virtual disk of several tens to several hundreds of GB is copied via the WAN 10, it takes a long time to complete mirroring. Thus, if mirroring of the virtual disks starts after migration of the VMs 11 is desired, it takes a considerable wait time until the VMs 11 are actually migrated. For this reason, mirroring for a preparation purpose for VM migration is preferable before the occurrence of a request for migration of the VMs 11.

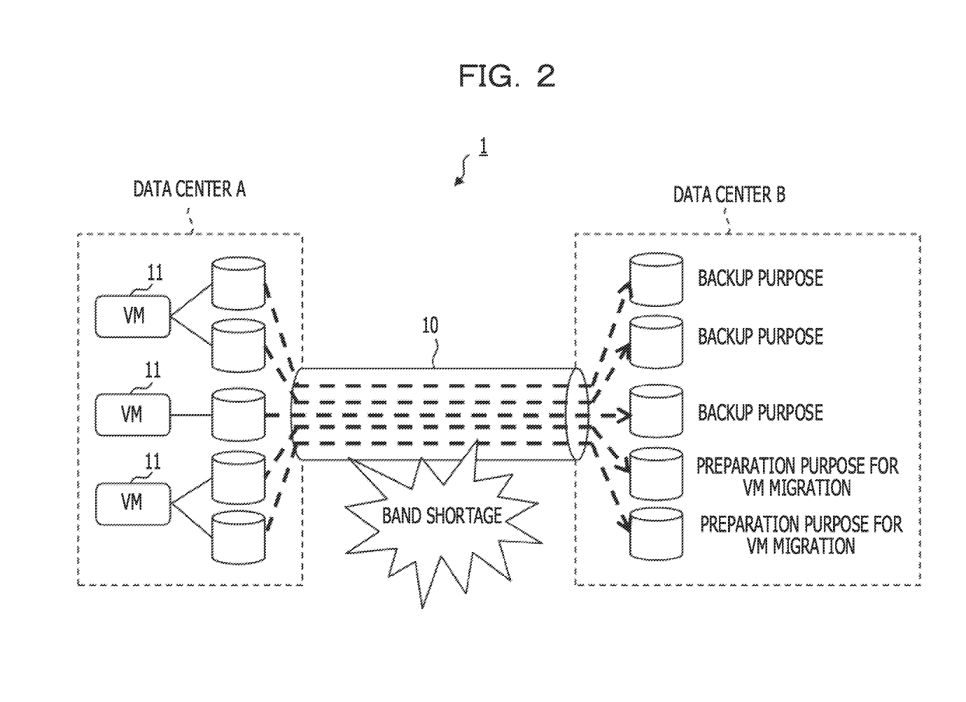

However, as depicted in FIG. 2, mirroring for a backup purpose for disaster recovery DR or the like and mirroring for a preparation purpose for VM migration are both performed via the WAN 10 between data centers. Each data center manages several thousands of VMs 11, and each VM 11 often uses two or more virtual disks including a system virtual disk and a data disk. For this reason, the number of virtual disks to be mirrored is more than the number of VMs 11. Thus, as depicted in FIG. 2, a shortage of bands of the WAN 10 may occur. If a shortage of bands of the WAN 10 occurs, all mirroring processes during execution are delayed, irrespectively of the backup purpose or the preparation purpose for VM migration. This prolongs a period from the time when data at the mirroring-source data center A is updated to the time when the update of the data is reflected at the mirroring-destination data center B.

A request for immediacy of mirroring varies depending on the purpose of mirroring. For example, in mirroring for a backup purpose for disaster recovery DR, the update of data occurring at the mirroring-source data center A is preferably reflected immediately in the mirroring-destination data center B.

On the other hand, in mirroring for a preparation purpose for VM migration, the demand for reflecting the update of data occurring at the mirroring-source data center A immediately at the mirroring-destination data center B is low. That is, mirroring only has to end until migration of the VMs 11 is actually performed. As such, the demand for immediacy is high in mirroring for a backup purpose for disaster recovery DR or the like, and the demand for immediacy is lower in mirroring for a preparation purpose of VM migration compared with mirroring for a backup purpose for disaster recovery DR or the like.

Thus, in the present embodiment, a mirroring purpose is determined in consideration of a shortage of bands of the WAN. Then, according to the determined mirroring purpose, for data transfer for a mirroring purpose with a relatively low demand for immediacy (for example, a preparation purpose of VM migration), not all pieces of data are transferred, and data selected from data to be transferred is transferred. On the other hand, for data transfer for a mirroring purpose with a relatively high demand for immediacy (for example, a backup purpose for disaster recovery DR or the like), part of the bands of the WAN 10 is preferably allocated so as to allow immediate data transfer. With this, even if the data center A becomes unusable due to a disaster, the latest data of the data center A is allocated to the data center B, thereby allowing easy recovery.

Thus, in the present embodiment, in an environment where mirroring for a backup purpose between data centers and mirroring for a preparation purpose for VM migration are mixed together, mirroring for the backup purpose is determined as demanding immediacy, and mirroring is immediately performed. On the other hand, mirroring for the preparation purpose for VM migration is determined as not demanding immediacy, and data is selected from among data to be transferred and selected data is copied. With this, a shortage of bands is suppressed, and the occurrence of a delay in mirroring for the backup purpose is avoided.

In the following, description is made to the data transfer system 1 according to an embodiment capable of selecting transfer target data from among data to be transferred when a mirroring purpose is determined for the data to be transferred and the determination result indicates a specific transfer purpose.

Entire Structure of the Data Transfer System

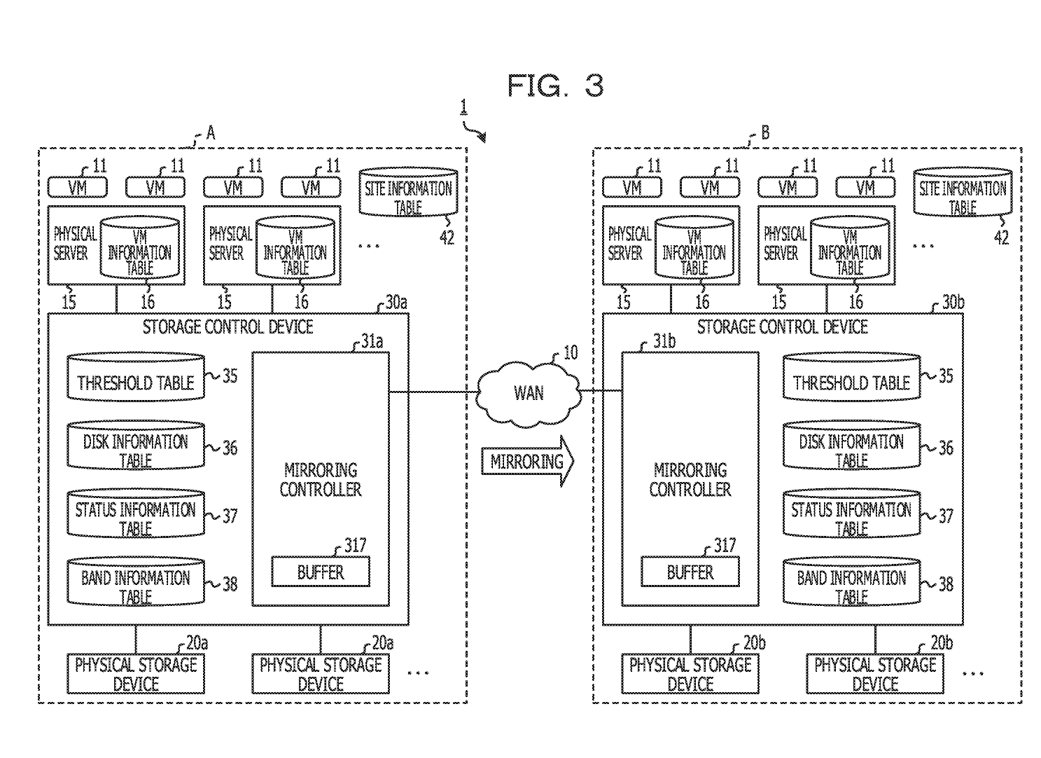

The entire structure of the data transfer system 1 according to an embodiment is described with reference to FIG. 3. FIG. 3 is a diagram depicting an entire structure of the data transfer system according to an embodiment. In the data transfer system 1 according to the present embodiment, the case is described in which data in virtual disks is transferred to the data center A to the data center B coupled together via the WAN 10. In this case, the data center A is a mirroring-source data center, and the data center B is a mirroring-destination data center. However, mirroring is not restricted thereto, and data transfer may be performed from the data center B to the data center A.

Since the data center A and the data center B have the same structure, only the structure of the data center A is described below. However, for the sake of identification, differentiation is made such that the data center A includes a physical storage device 20a, a storage control device 30a, and a mirroring controller 31a and the data center B includes a physical storage device 20b, a storage control device 30b, and a mirroring controller 31b.

The data center A has a physical server 15, the physical storage device 20a, and the storage control device 30a. The number of physical servers 15 and the number of physical storage devices 20a operated in the data center A may be any as long as each number is equal to or larger than 1. In the present embodiment, the data center A has a plurality of physical servers 15 and a plurality of physical storage devices 20a. In the following, a physical server is simply referred to as a server, and a physical storage device is simply referred to as a storage device.

On the server 15, a plurality of VM 11 (virtual servers) are constructed. The VMs 11 are generated by virtual machine software. In the data center A of the present embodiment, two servers 15 holding two VMs 11 are installed. The VMs 11 on the server 15 are coupled to the storage device 20a via the storage control device 30a.

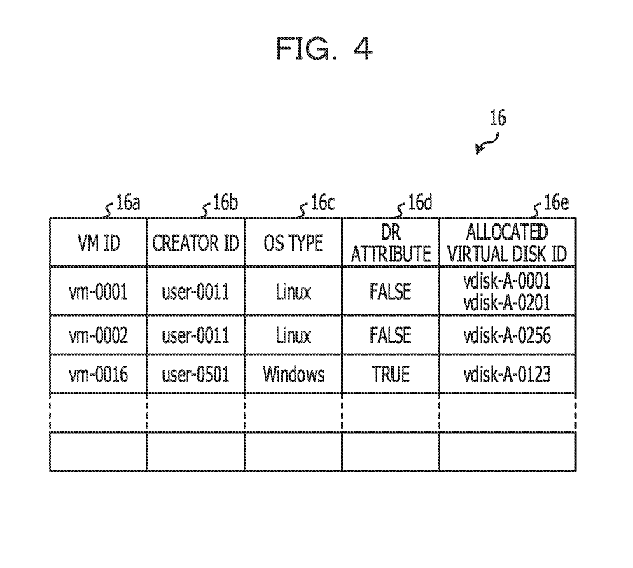

The server 15 has a VM information table 16. In the VM information table 16, information regarding the plurality of VMs 11 is stored. FIG. 4 depicts an example of a VM information table 16. In the VM information table 16, IDs 16a of the VMs 11, a creator ID 16b, an OS type 16c, a DR attribute 16d, and an allocated virtual disk ID 16e are stored. For example, the DR attribute 16d is set as “true” when the VM 11 is a target for disaster recovery DR, and is set as “false” when the VM 11 is not a target for disaster recovery DR.

The storage control device 30a controls the storage device 20a, virtualizing the storage device 20a and providing a virtual disk of a unit not constrained by the physical structure to the server 15. With this, the storage control device 30a virtually provides the server 15 with a plurality of storage devices as one storage device or provides one storage device as a plurality of storage devices. Thus, the server 15 only issues an input/output request (a read request or a write request) for a virtual disk to the storage control device 30a, and does not have to recognize which storage device 20a is being used for operation. The storage control device 30a reads from or writes to the storage device 20a in response to a request from the server 15.

The storage control device 30a has the mirroring controller 31a. The mirroring controller 31a transfers data in a virtual disk to the data center B (mirroring). The mirrored data is used for disaster recovery DR or the like. The mirroring controller 31a has a buffer 317 accumulating data stored in a virtual disk in accordance with generation of the virtual disk and update data for the virtual disk not yet transferred to the mirroring controller 31b of the mirroring destination. The mirroring controller 31a is an example of the data transfer apparatus.

The storage control device 30a has a threshold table 35, a disk information table 36, a status information table 37, and a band information table 38. In the threshold table 35, a threshold for use in determining whether the WAN 10 has a shortage of bands and a threshold for use in determining a read frequency of data are set.

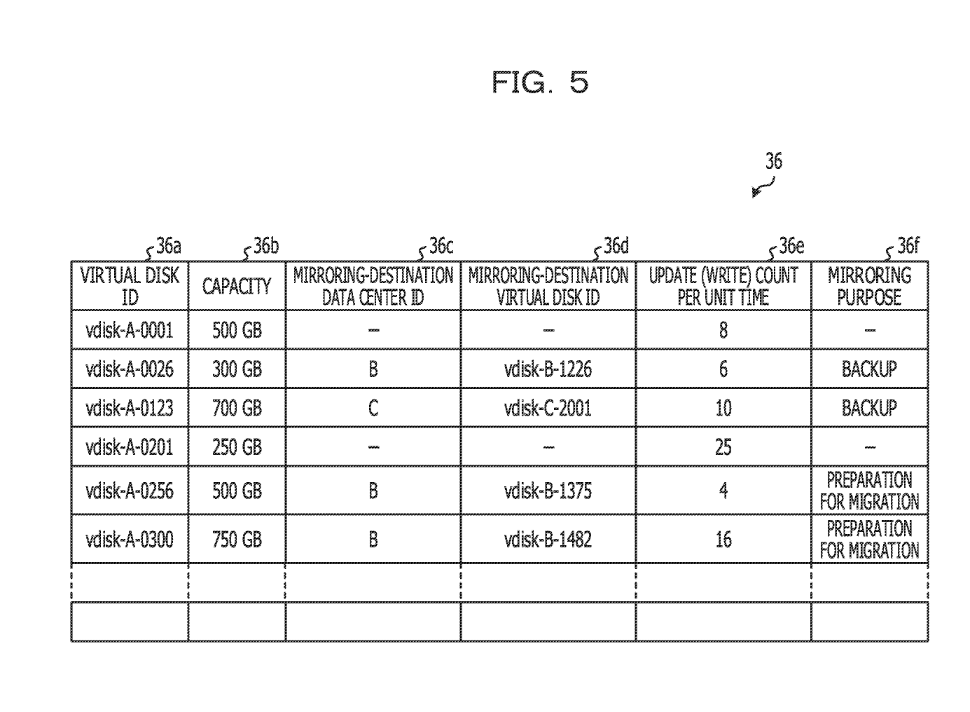

In the disk information table 36, information regarding virtual disks is stored. FIG. 5 depicts an example of the disk information table 36. In the disk information table 36, a virtual disk ID 36a, a capacity 36b, a mirroring-destination data center ID 36c, a virtual disk ID 36d created in the mirroring destination, an update (write) count per unit time 36e, and a mirroring purpose 36f are stored.

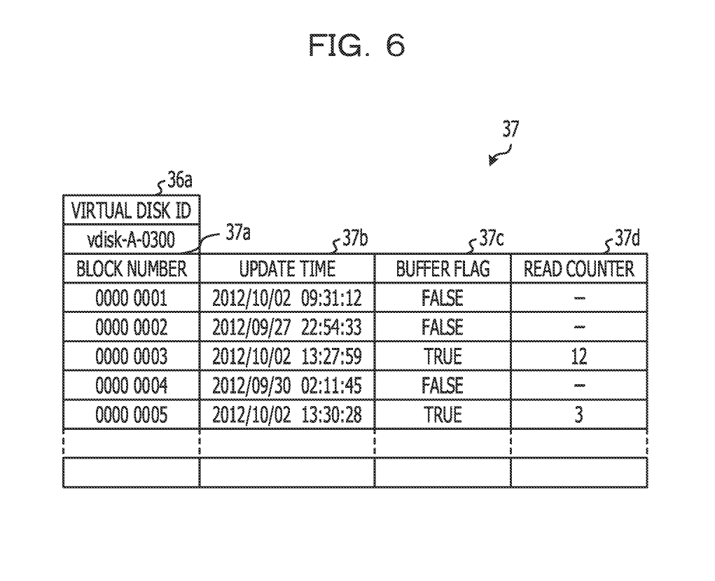

In the status information table 37, information about each block of the virtual disks is stored. That is, each virtual disk is divided into a plurality of blocks. FIG. 6 depicts an example of the status information table 37. In the status information table 37, a block number 37a, an update time 37b, a buffer flag 37c, and a read counter 37d, for example, are stored for each block regarding a virtual disk identifiable with the virtual disk ID 36a. The buffer flag 37c and the read counter 37d will be described further below.

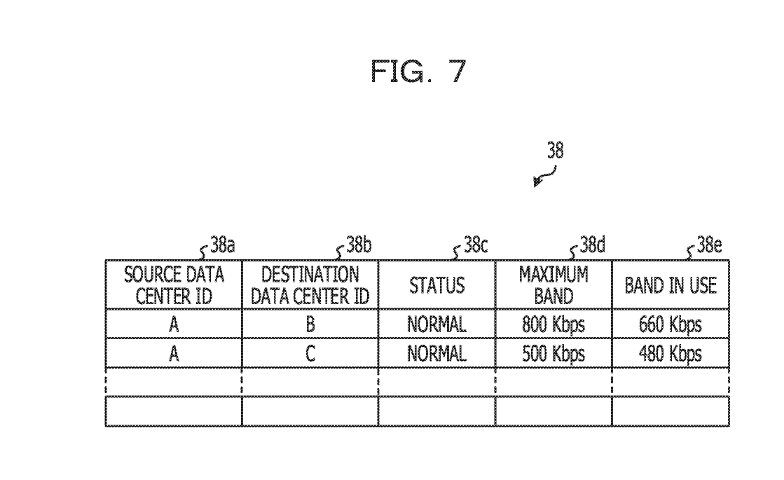

In the band information table 38, information regarding bands of the WAN 10 is stored. FIG. 7 depicts an example of the band information table 38. In the band information table 38, a data center ID 38a on a source provider side using the WAN 10 (here, for example, an ID of the data center A), a destination data center ID 38b as a data transfer destination (here, for example, an ID of the data center B), a band status 38c, a maximum band 38d, and a band in use 38e are stored.

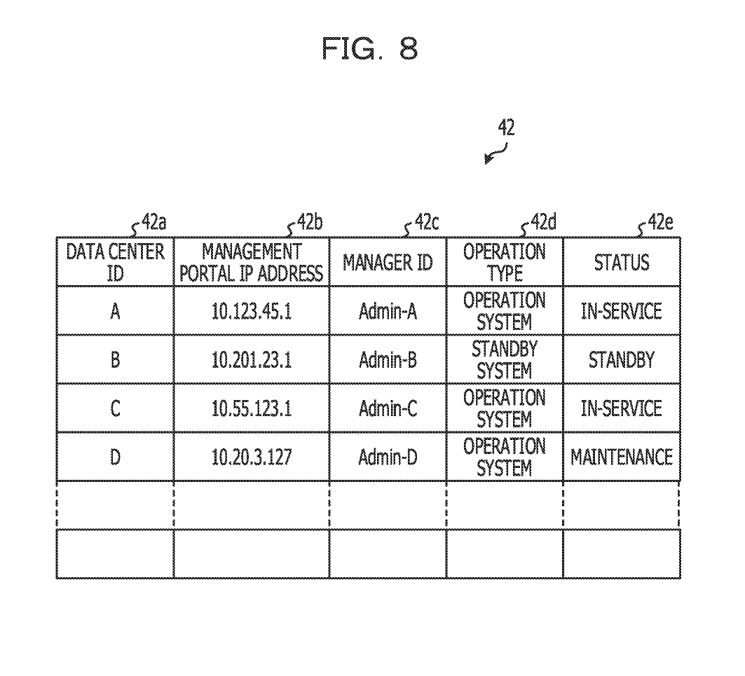

The site information table 42 stores information regarding all data centers. FIG. 8 depicts an example of the site information table 42. In the site information table 42, a data center ID 42a, a management portal IP address 42b, a manager ID 42c, an operation type 42d, and a status 42e are stored. For example, the operation type 42d is set as “operation system” when the data center identified with the data center ID 42a performs system operation and as “standby system” when the data center is in a state of standby for disaster recovery DR. Updated contents of the site information table 42 are reflected to the site information table 42 held by another data center.

Functional Structure of the Storage Control Device

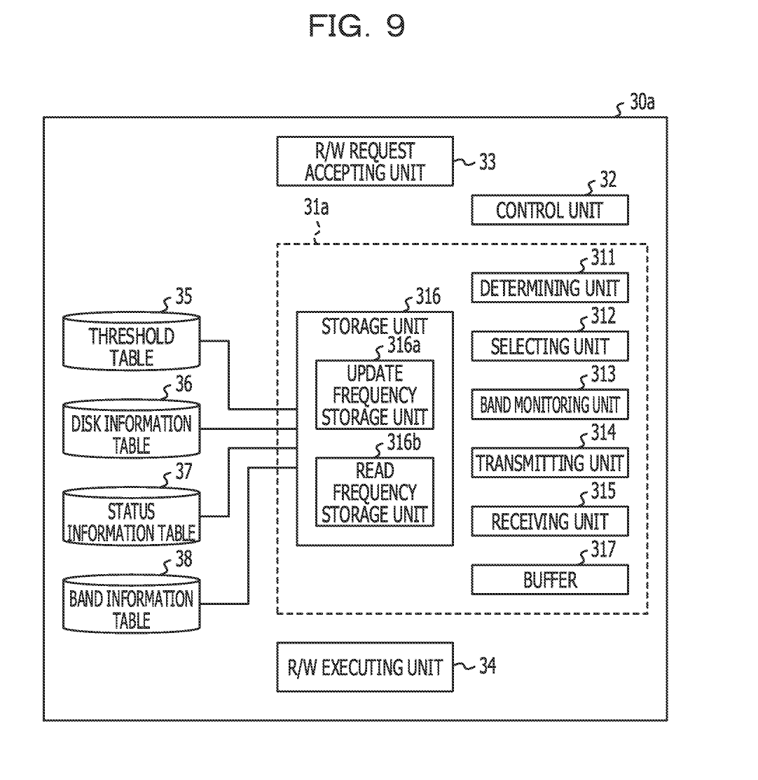

Next, the functional structure of the storage control device 30a according to an embodiment is described with reference to FIG. 9. FIG. 9 depicts a functional structure of the storage control device according to an embodiment.

The storage control device 30a according to the present embodiment has a control unit 32, a R/W request accepting unit 33, a R/W executing unit 34, the threshold table 35, the disk information table 36, the status information table 37, and the band information table 38.

The control unit 32 controls the entire storage control device 30a. The control unit 32 dynamically creates and deletes a virtual disk in the storage device 20a in response to an input/output request from the server 15. The control unit 32 executes read and write of data from and to a virtual disk in response to a request from the server 15.

The R/W request accepting unit 33 accepts an input/output request from the server 15. In response to an input/output request from the R/W request accepting unit 33, the R/W executing unit 34 writes data in a predetermined virtual disk in the storage device 20a or reads data and sends the read data to the server 15.

The storage control device 30a has the threshold table 35, the disk information table 36, the status information table 37, and the band information table 38. However, these tables may be stored in a storage region outside the storage control device 30a. Even in that case, the threshold table 35, the disk information table 36, the status information table 37, and the band information table 38 are managed by the storage unit 316.

Functional Structure of the Mirroring Controller 31a

The mirroring controller 31a is incorporated in the storage control device 30a, and has an extended function of the storage control device 30a regarding data transfer. However, this is not meant to be restrictive, and the mirroring controller 31a may be configured separately from the storage control device 30a. The mirroring controller 31a performs data transfer with the mirroring controller 31b in the data center B.

The mirroring controller 31a has a determining unit 311, a selecting unit 312, a band monitoring unit 313, a transmitting unit 314, a receiving unit 315, a storage unit 316, and the buffer 317.

The determining unit 311 determines a transfer purpose of data in a virtual disk stored in the storage device 20a. The data in the virtual disk includes data written when a virtual disk is generated and update data when the virtual disk is updated. The data in the virtual disk may also include all pieces of data included in the virtual disk or data for each block obtained by dividing the data included in the virtual disk.

Regarding data determined by the determining unit 311 as having a specific transfer purpose, the selecting unit 312 selects data to be copied from a virtual disk stored in the storage device 20a to the storage device 20b in the data center B.

The band monitoring unit 313 monitors the status of the WAN 10, such as a use amount of the bands of the WAN 10. The band monitoring unit 313 regularly (for example, for every one minute) monitors the bands of the WAN 10. The results are stored as appropriate in the band information table 38.

The transmitting unit 314 transmits the data selected by the selecting unit 312 to the data center B. The receiving unit 315 receives data via the WAN 10.

The storage unit 316 stores data in the threshold table 35, the disk information table 36, the status information table 37, and the band information table 38. In particular, an update frequency storage unit 316a stores the update count (an example of update frequency) 36e on the disk information table 36. A read frequency storage unit 316b stores the read counter 37d (an example of read frequency of data for each block) on the status information table 37.

Data not selected by the selecting unit 312 as a mirroring target is not immediately transferred to the data center B. Thus, the buffer 317 temporarily accumulates the data not selected as a mirroring target. Regarding the data accumulated in the buffer 317, the storage unit 316 sets the buffer flag 37c as “true” in units of blocks of the virtual disk IDs, as depicted in the status information table 37 of FIG. 6. Regarding a block with a virtual disk ID not accumulated in the buffer 317, the storage unit 316 sets the buffer flag 37c as “false”.

Operation of the Storage Control Device

Next, the operation of the storage control device 30a is described. The storage control device 30a performs the following process in response to an input/output request (a read request or a write request).

Read Request

When accepting a request for reading a predetermined virtual disk from the server 15, the R/W request accepting unit 33 reads data in the predetermined virtual disk from the storage device 20a, and sends the read data to the server 15.

Write Request

When accepting a request for writing in a predetermined virtual disk from the server 15, the R/W request accepting unit 33 writes data in the predetermined virtual disk in the storage device 20a, and sends an update completion notification to the server 15. When the virtual disk is a mirroring target, the R/W executing unit 34 sends an update notification to the mirroring controller 31a, and waits for a process completion notification (acknowledgement (ACK)) from the mirroring controller 31a.

Update Request from a Remote Mirroring Controller

A data update request from a remote mirroring controller (here, the mirroring controller 31b) is received by the receiving unit 315 of the mirroring controller 31a. The R/W executing unit 34 writes update data included in the update request received by the receiving unit 315 in the storage device 20a. The transmitting unit 314 notifies the remote mirroring controller 31b of process completion (ACK).

Operation of the Mirroring Controller

Next, the operation of the mirroring controller 31a is described. The mirroring controller 31a accepts a notification of updating data in the virtual disk embodied by the storage control device 30a.

When the bands of the WAN 10 are sufficient, the transmitting unit 314 transfers update data to the mirroring controller 31b, and waits for an update completion notification (ACK) from the mirroring controller 31b. Upon receiving an update completion notification (ACK) from the mirroring controller 31b, the mirroring controller 31a notifies the storage control device 30a of process completion (ACK).

When the bands of the WAN 10 are insufficient, regarding data for the preparation purpose for VM migration, the storage unit 316 stores update data in the buffer 317. That is, the transmitting unit 314 does not transfer the update data to the mirroring controller 31b of the mirroring destination. The storage unit 316 notifies the storage control device 30a of process completion (ACK).

The storage unit 316 sets “true” in the buffer flag 37c in the status information table 37 as a flag indicating that data has been buffered, and sets the read counter 37d at “0”.

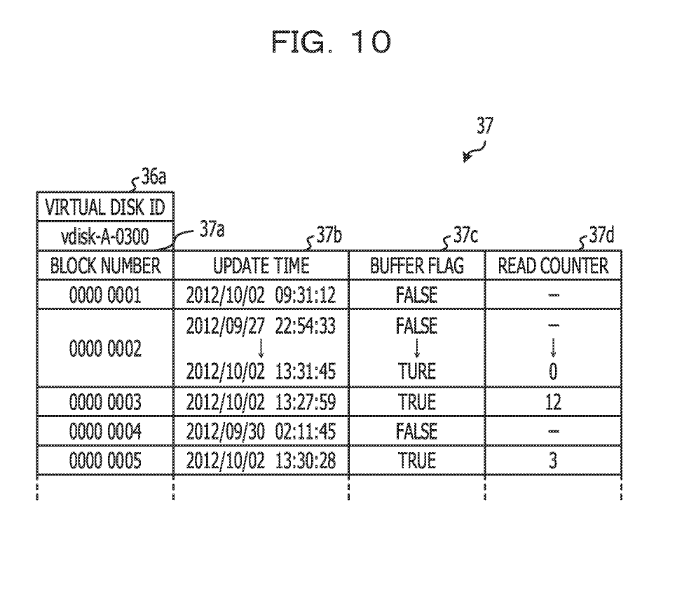

For example, the case is specifically described in which a write occurs in a block number 37a of “0000 0002” of the virtual disk ID 36a as depicted in FIG. 10. It is assumed that data with the block number 37a of “0000 0002” is updated (a write occurs) at 13:31:45, Oct. 2, 2012. Here, it is also assumed that since the bands of the WAN 10 is in an insufficient state and the updated data is data for a preparation purpose for VM migration, the data is not transferred to the mirroring-destination mirroring controller 31b but is stored in the buffer 317. In this case, the storage unit 316 sets “true” in the buffer flag 37c of the block number 37a of “0000 0002”, sets “0” in the read counter 37d, and stores “2012/10/02 13:31:45” in the update time 37b. The read counter 37d may be reset to “0” at every predetermined time.

Even if the bands of the WAN 10 are insufficient, regarding data for a backup purpose, the transmitting unit 314 transfers the updated data to the mirroring controller 31b, and performs an update completion notifying process similar to that when the bands of the WAN 10 are sufficient.

The selecting unit 312 selects data to be transferred from among the update data accumulated in the buffer 317 in a range allowable by the bands of the WAN 10 for every predetermined time. Specifically, the selecting unit 312 sequentially selects data by putting a higher priority on data with the buffer flag 37c set as “true” and a large read count indicated by the read counter 37d. As such, the read counter 37d indicates a frequency of reading data stored in the buffer 317. The transmitting unit 314 transfers the selected data to the mirroring controller 31b. The receiving unit 315 waits for an update completion notification (ACK) from the mirroring controller 31b. When an update completion notification (ACK) is received, the storage unit 316 sets “false” in the buffer flag 37c with the block number 37a on the status information table 37 for the transfer data, and also sets “- (indicating that the block is not buffered (example: NULL))” in the read counter 37d.

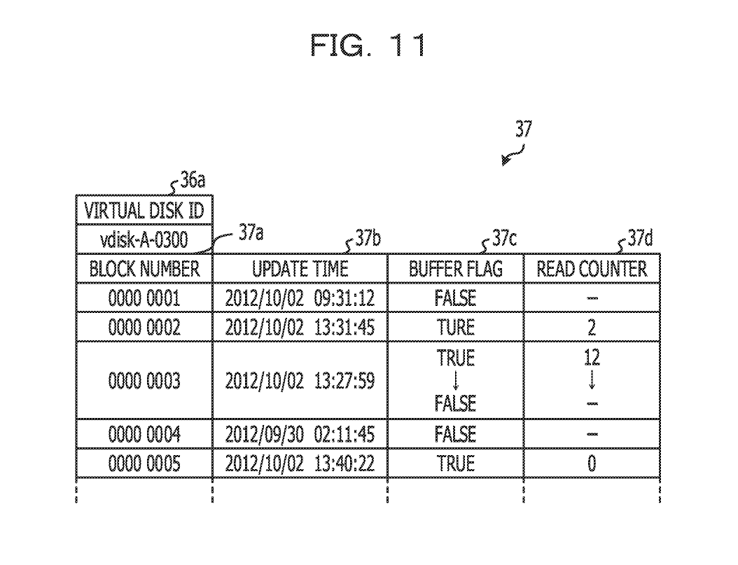

For example, it is assumed that the status is determined based on the use amount of the bands of the WAN 10 as such that one block of the update data accumulated in the buffer 317 is transmittable. In this case, as depicted in FIG. 11, data with a block number 37a of “0000 0003” having a maximum value of the read counter 37d, that is, “12”, is selected among the blocks having the buffer flag 37c in the status information table 37 as indicating “true”. The selected data is transferred to the mirroring controller 31b. When the selected data is transferred, the data in the buffer 317 has been transferred, and therefore may be deleted from the buffer 317. Therefore, the buffer flag 37c with the block number 37a of “0000 0003” is set as “false”, and the read counter 37d is set as “-”.

In Cases where Data is Read

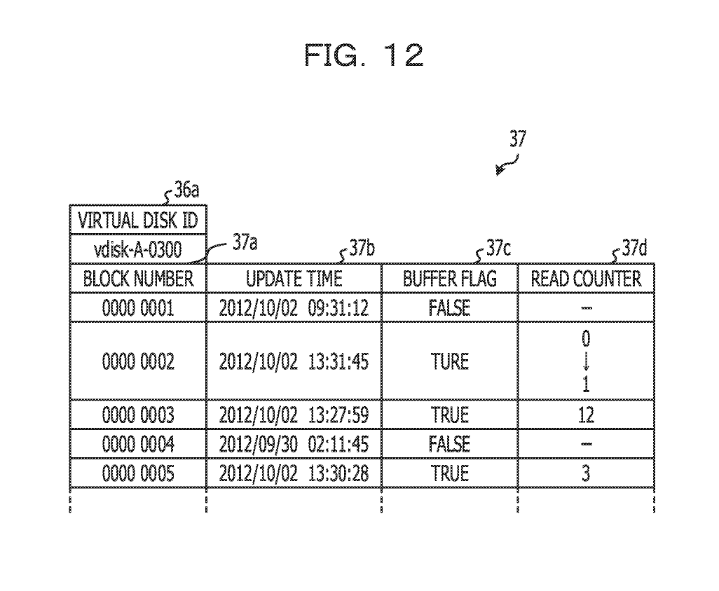

Next, the operation of the mirroring controller 31a when the same data as the data in the buffer 317 is read from the storage device 20a is described. In this case, if the read data has a buffer flag 37c set as “true” with the block number 37a in the status information table 37, the storage unit 316 increments the read counter 37d by 1. As depicted in FIG. 12, with the data not being transmitted, for example, when data with a block number 37a of “0000 0002” in the buffer 317 is read by the R/W executing unit 34, the storage unit 316 increments the read counter 37d by 1 from “0” to “1”. The read data is sent to the server 15.

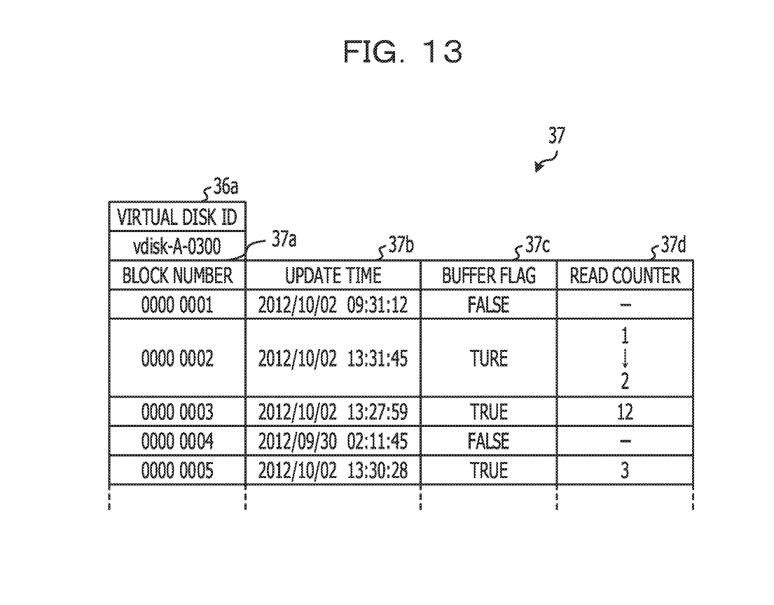

Furthermore, as depicted in FIG. 13, with data not being transmitted, when the data with the block number 37a of “0000 0002” is read again by the R/W executing unit 34, the storage unit 316 increments the read counter 37d by 1 from “1” to “2”. The read data is sent to the server 15.

In Cases where Data is Updated

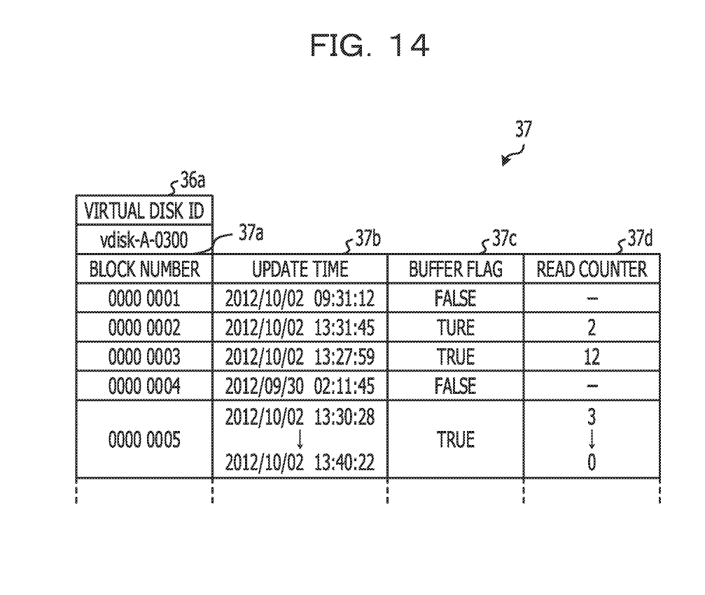

Next, the operation of the mirroring controller 31a when the same data as the data in the buffer 317 is updated by the storage device 20a is described. When the data in the virtual disk stored in the storage device 20a is updated, the storage unit 316 also updates data stored in the same buffer 317 as that for the updated data, as indicated by a block number 37a of “0000 0005” in FIG. 14. Here, the updated data is never read even once. Therefore, the storage unit 316 resets the read counter 37d at “0”.

When the value of the read counter 37d exceeds a threshold after a predetermined time elapses, the data may be selected as data to be reflected to the mirroring-destination storage device. In this case, if the value of the read counter 37d does not exceed the threshold, the data is not transferred, and accumulation in the buffer 317 continues. In the present embodiment, write and read of a virtual disk is performed in units of blocks obtained by dividing the virtual disk into plural, but this is not necessarily meant to be restrictive. Write and read may be performed in units of virtual disks.

As such, when the bands of the WAN are insufficient, for data for a preparation purpose for VM migration, the update data is not immediately transferred to the storage control device 30b but is stored in the buffer 317. Also, the status of the data in the buffer 317 is accumulated in the status information table 37.

In the following, the operation of the mirroring controller 31a is described from a process of determining a mirroring purpose and then a process of selecting data as a transfer target from data accumulated in the buffer 317.

Determination of Data Transfer (Mirroring) Purpose

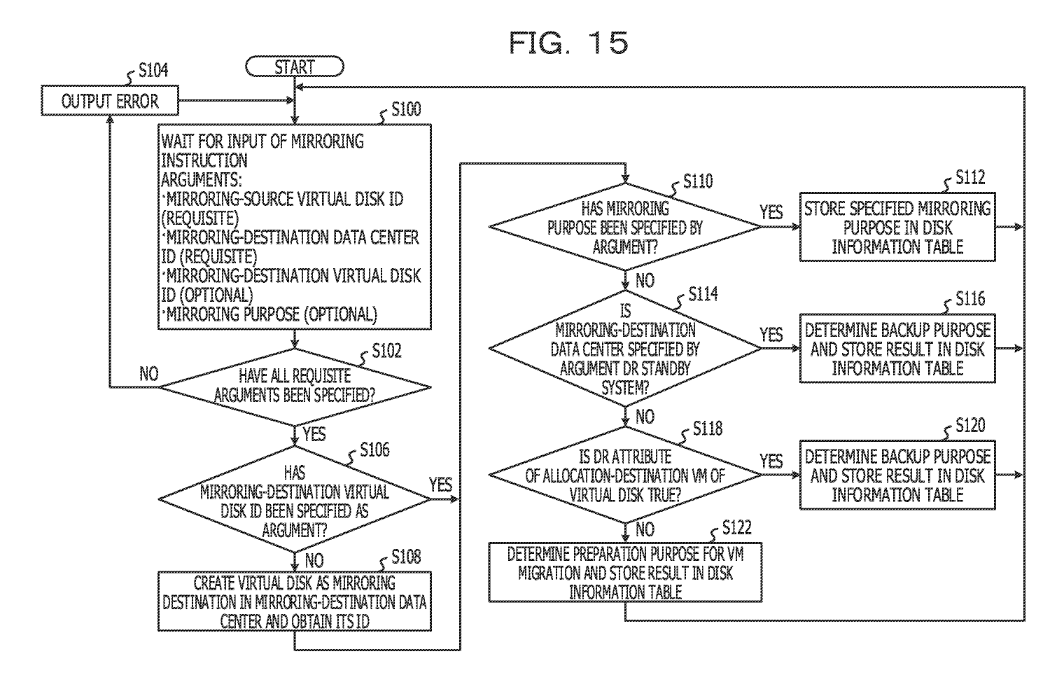

The process of determining a data transfer purpose according to the present embodiment is described with reference to FIG. 15. FIG. 15 is a flowchart of a data transfer purpose determining process according to an embodiment.

The mirroring controller 31a determines a mirroring purpose based on a virtual disk mirroring instruction from a client apparatus on an operation manager or user side. First, the R/W request accepting unit 33 waits for an input for a mirroring instruction requested from the server 15 upon reflection of the request from any VM 11 (step S100). The R/W request accepting unit 33 accepts the virtual disk ID of the mirroring source (here, the data center A) and the data center ID of the mirroring destination (here, the data center B) as input information for a mirroring instruction. In addition, the R/W request accepting unit 33 may accept the virtual disk ID of the mirroring destination and information about a mirroring purpose. However, the virtual disk ID of the mirror destination and the information about a mirroring purpose may not necessarily be specified, and may not be included in the input information.

Next, the determining unit 311 determines whether the virtual disk ID of the mirroring source and the data center ID of the mirroring destination are specified in the input information (step S102). When it is determined that the virtual disk ID of the mirroring source and the data center ID of the mirroring destination are not specified, the determining unit 311 outputs an error, and notifies the storage control device 30a as such (step S104).

When it is determined at step S102 that the virtual disk ID of the mirroring source and the data center ID of the mirroring destination are specified, the determining unit 311 determines whether a virtual disk ID of the mirroring destination is specified in the input information (step S106). When it is determined that a virtual disk ID of the mirroring destination is specified, the control unit 32 proceeds to step S110. On the other hand, when it is determined that a virtual disk ID of the mirroring destination is not specified, the determining unit 311 requests the storage control device 30b of the mirroring destination to create a virtual disk as a mirroring destination. The storage control device 30b creates a virtual disk as a mirroring destination in the storage device 20b of the mirroring destination, and issues a notification indicating a virtual disk ID of the mirroring destination. The determining unit 311 receives this notification, thereby obtaining the virtual disk ID of the mirroring destination (step S108).

Next, the determining unit 311 determines whether a mirroring purpose is specified in the input information (step S110). When it is determined that a mirroring purpose is specified, the determining unit 311 determines that the mirroring purpose of the target virtual disk is a specified purpose. The storage unit 316 stores the specified mirroring purpose in the disk information table 36 (step S112). When the mirroring purpose of the target virtual disk is a backup purpose, the storage unit 316 stores “backup” in the mirroring purpose 36f of FIG. 5. When the mirroring purpose is a purpose for migration of the VMs 11, the storage unit 316 stores “preparation for VM migration” in the mirroring purpose 36f of FIG. 5 (step S112), and the process then returns to step S100.

When it is determined at step S110 that a mirroring purpose is not specified, the determining unit 311 determines whether the data center identified with the data center ID of the mirroring destination is a standby system for disaster recovery DR (step S114). When the data center is determined as a standby system for disaster recovery DR, the determining unit 311 determines that the mirroring purpose of the target virtual disk is a backup purpose. The storage unit 316 stores in the disk information table 36 that the determined mirroring purpose is the backup purpose (step S116), and the process then returns to step S100.

For example, based on the site information table 42 of FIG. 8, the determining unit 311 determines that the operation type 42d with a data center ID 42a of the mirroring destination being “B” is a “standby system” and the data center B is a standby system for disaster recovery DR. The storage unit 316 stores “backup” in the mirroring purpose 36f of FIG. 5.

When it is determined at step S118 that the data center identified with the storage device ID of the mirroring destination is not a standby system for disaster recovery DR, the determining unit 311 determines whether the DR attribute of the VM 11 of a virtual disk allocation destination is “true” (step S118). If it is determined that the DR attribute of the VM 11 of the virtual disk allocation destination is “true”, the determining unit 311 determines that the mirroring purpose of the target virtual disk is a backup purpose. The storage unit 316 stores in the disk information table 36 that the determined mirroring purpose is a backup purpose (step S120), and the process then returns to step S100.

When it is determined at step S118 that the DR attribute of the VM 11 of the virtual disk allocation destination is not “true”, the determining unit 311 determines that the mirroring purpose of the target virtual disk is a preparation purpose for VM migration. The storage unit 316 stores in the disk information table 36 that the determined mirroring purpose is a preparation purpose for VM migration (step S122), and the process then returns to step S100.

For example, based on the VM information table 16 of FIG. 4, the determining unit 311 determines whether the DR attribute 16d with the ID 16a of the VM 11 of the virtual disk allocation destination is “true”. When the DR attribute 16d is “true”, it is determined that the data center B is a standby system for disaster recovery DR. In this case, the storage unit 316 stores “backup” in the mirroring purpose 36f of FIG. 5.

As has been described above, according to the storage control device 30 of the present embodiment, even if the mirroring purpose is not specified, the determining unit 311 determines the mirroring purpose based on whether the data center of the mirroring destination functions as standby for disaster recovery DR. For example, what is set in advance in the site information table 42 for each data center is that the data center A is used for system operation, the data center B is for standby at the time of a disaster, and the like. Also, the DR attribute for each VM 11 is set in the VM information table 16. Therefore, in the storage control device 30 according to the present embodiment, based on the information in these tables, the mirroring purpose may be determined by determining whether the data center B of the mirroring destination is a standby system for disaster recovery DR and the DR attribute for each VM 11 is “true”.

Selection of Transfer Target Data

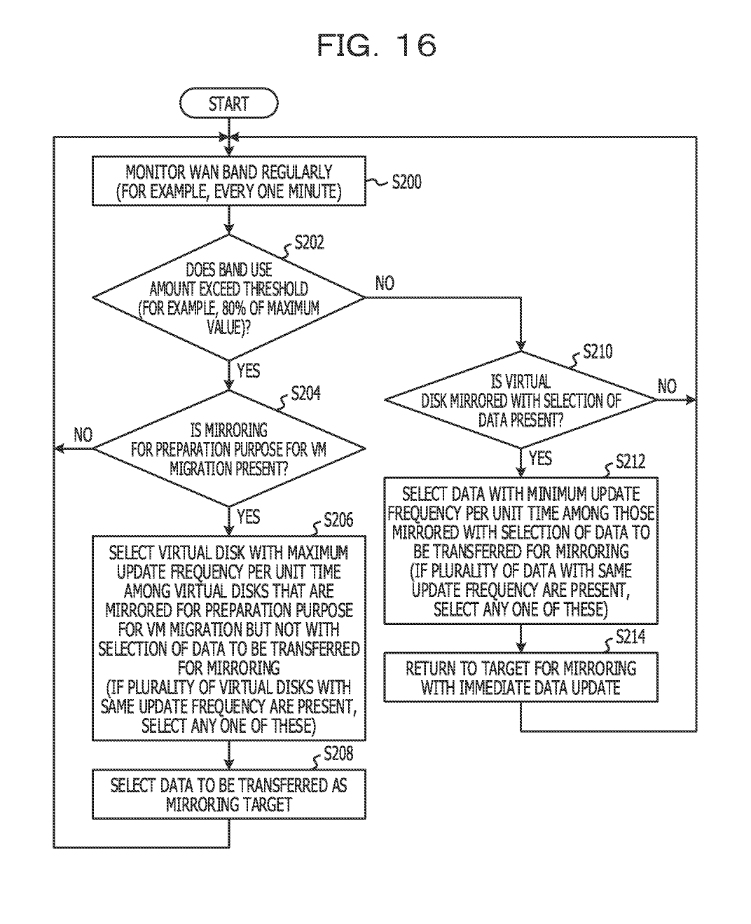

Next, a transfer target data selecting process according to the present embodiment is described with reference to FIG. 16. FIG. 16 is a flowchart of a transfer target data selecting process according to an embodiment.

Virtual Disk Selection

The band monitoring unit 313 regularly (for example, every one minute) monitors the bands of the WAN 10 between the data centers A and B (step S200). Next, the determining unit 311 determines whether the band use amount exceeds a threshold (step S202).

For example, as a case in which the occurrence of a band shortage is predicted, the band monitoring unit 313 determines whether the band use amount exceeds a threshold stored in the threshold table 35. In the present embodiment, the band monitoring unit 313 determines whether the band use amount exceeds 80% of a maximum band 38d with a source data center ID in the band information table 38 of FIG. 7 being “A”.

When it is determined that the band use amount exceeds the threshold, the determining unit 311 determines whether the mirroring target virtual disk is for mirroring for a preparation purpose for VM migration (step S204). When it is determined that the mirroring target virtual disk is not for mirroring for a preparation purpose for VM migration, the determining unit 311 determines that mirroring is for a backup purpose for disaster recovery DR or the like, and the process then returns to step S200.

As a result, mirroring for the backup purpose for disaster recovery DR or the like is continuously performed in consideration of immediacy. That is, mirroring when the bands of the WAN 10 described above are sufficient is performed. With this, in mirroring for a backup purpose for disaster recovery DR or the like, the data in a virtual disk may be immediately backed up to the storage device 20b of the mirroring destination.

When it is determined at step S204 that mirroring is for a preparation purpose for migration of the VMs 11, the selecting unit 312 selects a virtual disk with a maximum data update frequency per unit time among virtual disks mirrored for a preparation purpose for VM migration but not with selection of data to be transferred for mirroring (step S206). Here, if a plurality of virtual disks with the same maximum update frequency are present, the selecting unit 312 selects any one of these.

Specifically, the selecting unit 312 selects a virtual disk as a mirroring target based on the update count 36e per unit time in the disk information table 36. The selecting unit 312 sequentially selects a virtual disk with a lower update frequency as a mirroring target. For example, in the case of the disk information table 36 of FIG. 5, the selecting unit 312 selects a virtual disk (a virtual disk ID of vdisk-A-0300) with an update count 36e of “16” among virtual disks for a preparation purpose for VM migration without immediacy.

A virtual disk with a high update frequency causes frequent data transfer to the mirroring controller 31b of the mirroring destination. To avoid this, the degree of priority of mirroring is decreased for virtual disks with a high update count, thereby suppressing a constraint of the bands of the WAN 10.

Next, the selecting unit 312 selects data to be transferred as a mirroring target (step S208). When the entire virtual disk is to be transferred, the selecting unit 312 takes the entire data of the virtual disk selected at step S206 as a mirroring target.

Selection of Part of the Virtual Disk

On the other hand, when part of the virtual disk is transferred, a block to be transferred is selected among a plurality of blocks obtained by dividing the selected virtual disk.

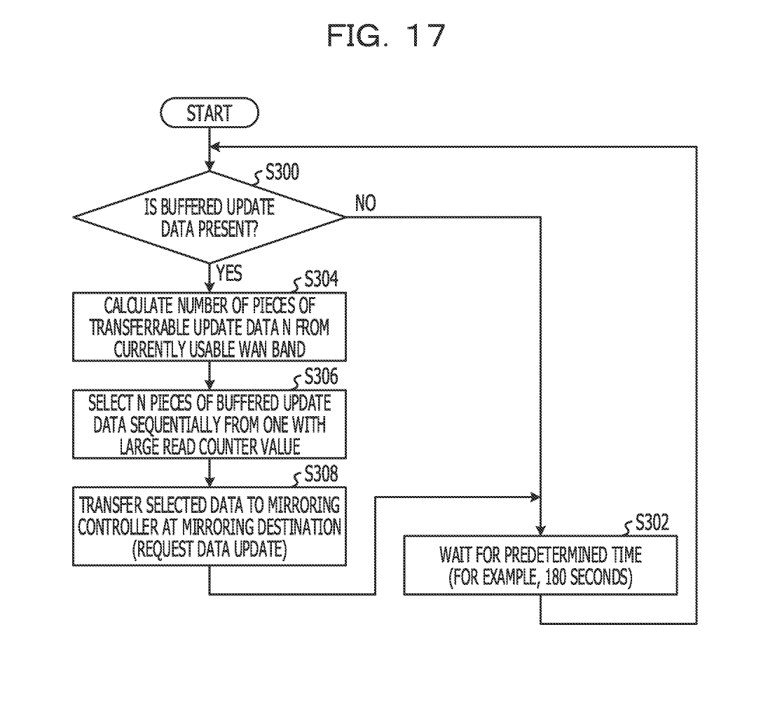

The process at step S208 of selecting data to be transferred from data to be transferred is described in detail with reference to FIG. 17. FIG. 17 is a flowchart of a transfer target data selecting process in units of blocks.

First, the selecting unit 312 determines at step S300 whether update data accumulated in the buffer 317 is present. When it is determined that no update data accumulated in the buffer 317 is present, the selecting unit 312 waits for a predetermined time (for example, 180 seconds) (step S302), and the process then returns to step S300.

On the other hand, when it is determined that update data accumulated in the buffer 317 is present, the selecting unit 312 calculates the number of pieces of transferrable update data, N, from a currently usable band of the WAN 10 (step S304). Next, the selecting unit 312 sequentially selects, in units of blocks, N pieces of data from blocks of virtual disks with a large value of the read counter 37d among the update data accumulated in the buffer 317 (step S306).

Next, the transmitting unit 314 transmits the selected data to the mirroring controller 31b of the mirroring destination (step S308), making a request for data update of the storage device 20b of the mirroring destination.

As such, when part of the virtual disk is transferred in units of blocks, a determination as to whether the data is taken as a mirroring target is made by using the read count, and data with a large read count is copied with priority. With this, data often used is stored earlier in the storage device of the mirroring destination, and data hardly used is stored later in the storage device of the mirroring destination.

Referring back to step S202 of FIG. 16, when it is determined that the band use amount does not exceed the threshold set in the threshold table 35, the determining unit 311 determines whether a virtual disk mirrored with selection of data to be transferred is present (step S210). Examples of the case in which it is determined that the band use amount does not exceed the threshold include the case of no shortage of the bands of the WAN 10 and the case in which the previously-existing shortage of bands of the WAN 10 has been resolved.

When it is determined at step S210 that a virtual disk mirrored with selection of data is not present, the process returns to step S200. On the other hand, when it is determined at step S210 that a virtual disk mirrored with selection of data is present, the selecting unit 312 selects data with a minimum update frequency per unit time among those mirrored with selection of data for mirroring (step S212). Here, if a plurality of pieces of data with a minimum update frequency are present, the selecting unit 312 selects any one of these. Next, mirroring for the preparation purpose for VM migration is returned to a target for mirroring with immediate data update (step S214). Thus, as with mirroring for the backup purpose, immediate transfer is performed also in mirroring for the preparation purpose for VM migration until a band shortage is next determined at step S202.

As has been described above, according to the selecting process of the present embodiment, virtual disk mirroring is not performed immediately in mirroring for the preparation purpose for VM migration, and transfer target data is selected from the data to be transferred and the selected data is mirrored. In this manner, by decreasing the data transfer frequency in mirroring for the preparation purpose for VM migration, consumption of the bands of the WAN 10 is suppressed.

Also, in the selecting process, frequent data update to the storage device of the mirroring destination constrains the bands of the WAN 10. For this reason, data of the virtual disk is selected so that a virtual disk with a low data update frequency is transferred first. As a result, the data of the often-written virtual disk is less transfer to the mirroring controller of the mirroring destination. With this, frequent data update to the storage device of the mirroring destination is suppressed, and band consumption in the WAN 10 is suppressed.

In addition, when part of the selected virtual disk is transferred in units of blocks, data with a relatively high use frequency is reflected, with priority, to the storage device of the mirroring destination. With this, data of a block assumed to have a higher use value is updated earlier to the storage device of the mirroring destination. Therefore, even among data for the preparation purpose for VM migration not demanding immediacy, data assumed to demand relatively high immediacy is mirrored with priority. As such, according to the data transfer system 1 of the present embodiment, since transfer data is selected in accordance with the data update frequency and read frequency of data, even if the data is dynamically changed during operation, optimum transfer data is selected accordingly.

Therefore, as for data frequently updated but not often used, update data transfer is automatically suppressed to suppress consumption of the network bands, and update data of data often used is automatically selected for transfer.

In the determining process according to the above-described embodiment, a preparation purpose for VM migration is exemplarily mentioned as a specific transfer purpose determined by the determining unit 311. However, this is not meant to be restrictive. Any transfer purpose may be a specific transfer purpose as long as the transfer purpose does not demand immediacy. For example, with deterioration of facilities such as a data center, when the storage device operated in that data center migrates to another storage device, the data in the storage device in the deteriorated data center migrates to another storage device. Such transfer purpose may be a specific transfer purpose without immediacy.

On the other hand, for example, data such as a status of a resource for use in system management is regularly written in a storage device, and there is a high possibility that the data is regularly read for display on a display of a device on a manager side. Such data is regarded as having an immediate transfer purpose, which is excluded from specific transfer purposes and is regarded as a mirroring purpose with immediacy, like a backup purpose.

Also, in the selecting process of the present embodiment, when a shortage of the bands of the WAN occurs and mirroring is for a preparation purpose for VM migration, virtual disk mirroring is not immediately performed, and data to be transferred from a virtual disk to be mirrored is selected. However, the selecting process according to the present embodiment may regularly be performed irrespectively of whether a shortage of the bands of the WAN occurs. With this, in mirroring for the preparation purpose for VM migration, the data transfer frequency is decreased, and consumption of the bands of the WAN 10 is further suppressed.

Also, in mirroring of the above-described embodiment, of two storage devices 20a and 20b, mirroring the inside of the virtual disk is performed from the storage device 20a to the storage device 20b by using bands of a network. However, mirroring the inside of the virtual disk may be performed from the storage device 20b to the storage device 20a, and mirroring a virtual disk may be performed from another storage device not depicted in the drawings to the storage device 20a.

Example of Hardware Structure

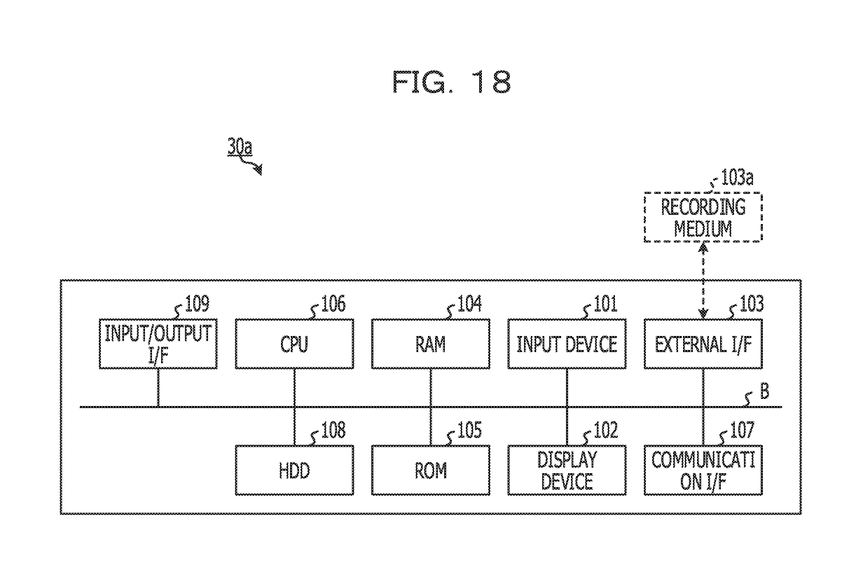

Finally, an example of hardware structure of the storage control device 30a is described. FIG. 18 is a diagram depicting an example of hardware structure of the storage control device according to the present embodiment.

As depicted in FIG. 18, the storage control device 30a includes an input device 101, a display device 102, an external I/F 103, a random access memory (RAM) 104, a read only memory (ROM) 105, a central processing unit (CPU) 106, a communication I/F 107, a hard disk drive (HDD) 108, and an input/output I/F 109, which are mutually coupled to each other via a bus B.

The input device 101 includes a keyboard, a mouse, and the like, and is used to input each operation to the storage control device 30a. The display device 102 includes a display and the like, and displays the system operation results and others for a manager of the storage control device 30a.

The communication I/F 107 is an interface for coupling the mirroring controller 31a incorporated in the storage control device 30a to the WAN 10. With this, the mirroring controller 31a performs remote mirroring with another mirroring controller via the communication I/F 107.

The HDD 108 is a non-volatile storage device having programs and data stored therein. Examples of the programs and data stored in the HDD 108 include an operating system (OS) as basic software for controlling the entire device and application software for providing various functions on the OS. Also, the HDD 108 stores programs to be executed by the CPU 106 for performing the mirroring purpose determining process and the transfer data selecting process in the above-described embodiments.

The external I/F 103 is an interface with an external apparatus. Examples of the external apparatus include a recording medium 103a. The storage control device 30a is able to read and/or write the recording medium 103a via the external I/F 103. Examples of the recording medium 103a include a compact disk (CD), digital versatile disk (DVD), an SD memory card, and a universal serial bus (USB) memory.

The ROM 105 is a non-volatile semiconductor memory (storage device), and stores programs and data such as those regarding basic input/output system (BIOS), operating system (OS) setting, and network setting to be executed at the time of start. The RAM 104 is a volatile semiconductor memory (storage device) which temporarily retains a program or data. The CPU 106 is a computing device which reads a program or data from any of the above-described storage devices (for example, “HDD” or “ROM”) and performs processes to control the entire device and perform a mount function.

The input/output I/F 109 is an interface with the server 15. With this, the storage control device 30a is able to accept a read request and a write request to the storage device 20a from the server 15 via the input/output I/F 109.

The control unit 32, the R/W request accepting unit 33, the R/W executing unit 34, and the mirroring controller 31a are each embodied by a process the CPU 106 is caused to perform by a program installed in the HDD 108. The threshold table 35, the disk information table 36, the status information table 37, and the band information table 38 are attainable by using, for example, the RAM 104, the HDD 108, or a storage device coupled to the storage control device 30a via the WAN 10.

As has been described in the foregoing, with the hardware structure described above, the storage control device 30a according to the present embodiment is able to provide the mirroring purpose determining process and the transfer data selecting process in the above-described embodiment.

While the data transfer apparatus, data transfer system, data transfer method, and program have been described by using the embodiments, these embodiments are not restrictive, and various modifications and improvements may be made in a range of the embodiments.

While transfer of data in a virtual disk has been described above by way of example, the data transfer system according to any of the embodiments is applicable to transfer of data in a physical disk.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention.

Although the embodiments of the present invention have been described in detail, it should be understood that the various changes, substitutions, and alterations could be made hereto without departing from the spirit and scope of the invention.

What is claimed is:

1. An apparatus comprising:
a memory; and
a processor coupled to the memory and configured to:
determine a transfer purpose of data to be transferred from a first storage device to a second storage device via a network, and
select transfer target data from data in the first storage device based on the determined transfer purpose of the data.

2. The apparatus according to claim 1, wherein the processor is configured to:
monitor bands of the network, and
select the transfer target data based on the determined transfer purpose of the data and a use amount of the bands of the network.

3. The apparatus according to claim 1, wherein the processor is configured to:
select the transfer target data based on the determined transfer purpose of the data and an update frequency of the data stored in the first storage device.

4. The apparatus according to claim 1, wherein the first storage device stores the data in units of blocks,
wherein the processor is configured to:
select a block of the transfer target data based on the determined transfer purpose of the data and a read frequency of data for each of the blocks in the first storage device.

5. The apparatus according to claim 1, wherein the processor is configured to:
perform a process of selecting the transfer target data when the determined transfer purpose of the data indicates data transfer without immediacy.

6. A system comprising:
a first storage device;
a second storage device coupled to the first storage device via a network; and
a data transfer apparatus including a memory and a processor coupled to the memory,
wherein the processor is configured to:
determine a transfer purpose of data to be transferred from the first storage device to the second storage device, and
select transfer target data from data in the first storage device based on the determined transfer purpose of the data.

7. The system according to claim 6, wherein the processor is configured to:
monitor bands of the network, and
select the transfer target data based on the determined transfer purpose of the data and a use amount of the bands of the network.

8. The system according to claim 6, wherein the processor is configured to:
select the transfer target data based on the determined transfer purpose of the data and an update frequency of the data stored in the first storage device.

9. The system according to claim 6, wherein the first storage device stores the data in units of blocks,
wherein the processor is configured to:
select a block of the transfer target data based on the determined transfer purpose of the data and a read frequency of data for each of the blocks in the first storage device.

10. The system according to claim 6, wherein the processor is configured to:
perform a process of selecting the transfer target data when the determined transfer purpose of the data indicates data transfer without immediacy.

11. A transfer method of data between a first storage device and a second storage device via a network, the transfer method comprising:
determining a transfer purpose of the data to be transferred from the first storage device to the second storage device; and
selecting transfer target data from data in the first storage device based on the transfer purpose of the data determined by the determining.

12. The transfer method according to claim 11, further comprising:
monitoring bands of the network,
wherein the selecting selects the transfer target data based on the transfer purpose of the data determined by the determining and a use amount of the bands of the network obtained by the monitoring.

13. The transfer method according to claim 11, further comprising:
calculating an update frequency of the data stored in the first storage device,
wherein the selecting selects the transfer target data based on the transfer purpose of the data determined by the determining and the update frequency of the data calculated by the calculating.

14. The transfer method according to claim 13, wherein
the first storage device stores the data in units of blocks,
the calculating calculates a read frequency of data for each of the blocks, and
the selecting selects a block of the transfer target data based on the determined transfer purpose of the data and the read frequency of data for each of the blocks in the first storage device.

15. The transfer method according to claim 11, wherein
the selecting is performed when the transfer purpose of the data determined by the determining indicates data transfer without immediacy.
